(19) United States
(12) Patent Application Publication
(10) Pub. No.: US 2022/0281697 A1
(43) Pub. Date: Sep. 8, 2022

(54) A BEVERAGE PLAN AND CONVEYING SYSEM FOR BEVERAGE CONTAINERS

(71) Applicant: Anheuser-Busch InBev S.A., Brussels (BE)

(72) Inventors: Philippe Jean Marie DUPERRAY, Châteauroux (FR); Marcelo PETRAMALE, Leuven (BE); Wim DEKOCKER, Leuven (BE)

(21) Appl. No.: 17/631,345

(22) PCT Filed: Jul. 30, 2020
(86) PCT No.: PCT/EP2020/071602

§ 371 Date: Jan. 28, 2022

(30) Foreign Application Priority Data
Jul. 30, 2019 (EP) 19189030.0

(51) Int. Cl. B65G 54/02; B67C 3/24; B65G 47/68

(52) U.S. Cl. CPC B65G 54/02; B67C 3/24; B65G 47/68; B65G 2201/0244; B65G 2201/0252; B65G 2203/042

(57) ABSTRACT

The present invention is directed to a beverage plant comprising a conveying system (100), said conveying system comprising: at least one driving surface (102) including at least one planar tile (112) equipped with at least one coil; at least one mover (104) equipped with at least one permanent magnet for magnetically coupling the at least one mover to the at least one planar tile, the at least one mover is placed over the at least one tile of the at least one driving surface in a contactless manner and is configured to be moved, displaced and/or rotated in at least two degrees of freedom of movement; and wherein the at least one mover is configured to support at least one beverage container (203) or at least one package containing at least one beverage container placed over the at least one mover for being moved, displaced and/or rotated in at least two degrees of freedom of movement, as the at least one mover is moved, displaced and/or rotated while being magnetically coupled to the at least one planar tile. In addition, the present invention is directed to the use of the conveying system described earlier for conveying carbonated beverage containers, and in particular closed beverage containers.

### FIELD OF INVENTION

The present invention generally relates to a beverage plant. Further, it relates to conveying systems for beverage containers.

### BACKGROUND OF INVENTION

Conveying systems are the most necessary for manufacturing industries and other types of industries for moving products from one place to another. Older systems usually consist of tracks or conveyer belts driven by motors; and trays or containers containing products to be moved from one place to another are generally placed over the tracks or conveyor belts and move along with them. Such conveyer belts are restricted to only horizontal or slightly inclined curvilinear executions.

Further, conventional conveyors are limited in length per drive unit, because of powering the conveyer belts and forces existing on the belts, which makes it necessary to make chains of belts via left and right connections for longer transportation. Furthermore, such conveyer belts, due to restriction in their construction, are limited in terms of turning radius. Also, the types of products handled by these conveying systems are limited to the shapes, weight and other characteristics of the products.

Further, conventional conveyor systems are not flexible in the sense that creating quick conveying path adaptation, or re-routing, or by-passes, or parking, or buffering, or accumulation, or re-sequencing (sorting), cannot be achieved in real time, and even not with limited down-time.

Further, an inherent disadvantage of conveying by conventional conveyors or transportation systems as used in FMCG industries such as breweries, beer containers and especially e.g. aluminum cans or bottles or glass bottles are exposed to or cannot be exposed to high contact pressures in the line and in particular in buffer or accumulation lines. Consequently, such glass bottles in particular, and in general all bottles for carbonated beverages, currently, have to resistant high burst pressures, eg. minimum 7, 8, or 9 bar, and have a certain impact strength and consequently must have sufficiently thick walls (and consequently have been limited in terms of being light weighted).

Hence, it is an objective of the present invention to provide a beverage plant having conveying systems which are highly flexible, integrated, dynamic, programmable, with multi-dimensional freedom of movement and have broad range of application in both wet and dry areas.

Further, it is an objective to provide a beverage plant having conveying systems limiting the contact pressure between the beverage containers and decreasing the minimum required burst pressure and/or impact strength. Such beverage plant could handle beverage containers, in particular and not limited to glass bottles, with lower wall thickness, lower weight, and hence lower material cost than if they were handled by conventional conveyor and container handling systems.

### SUMMARY OF INVENTION

The present invention provides a beverage plant comprising a conveying system for conveying beverage containers, said conveying system comprising:
at least one driving surface including at least one planar tile equipped with at least one coil;
at least one mover equipped with at least one permanent magnet for magnetically coupling the at least one mover to the at least one planar tile, the at least one mover being placed over the at least one tile of the at least one driving surface in a contactless manner and being configured to be moved, displaced and/or rotated in at least two degrees of freedom of movement;
wherein the at least one mover is configured to support at least one beverage container or at least one package containing at least one beverage container for being moved, displaced and/or rotated in at least two degrees of freedom of movement.

Preferably, the at least one mover may be configured to be moved, displaced, tilted and/or rotated in at least six degrees of freedom of movement;

In an embodiment of the present invention, a beverage plant may be provided wherein the driving surface connects at least one beverage container processing station with another one. So, the planar movers may receive beverage containers from a processing station and feed it to another processing station. In the context of the present invention, beverage container process stations may be all processing station acting on beverage containers depalletizers, washers, rinsers, buffers, fillers, pasteurizers, labelers, secondary packers, tertiary packers, palletizers and/or inspection systems etc.

In another embodiment of the present invention, a beverage plant may be provided wherein the driving surface is extended through one or more beverage container processing stations. So, instead of “or in combination with” connecting process stations, the movers may convey beverage containers through one or more beverage container processing stations.

In another embodiment of the present invention, a beverage plant may be provided wherein the driving surface is at least partially in a circular or oval, or a ring, or irregularly profiled shape layout around one or more beverage container processing stations. So, optionally in combination with the foregoing, the movers may convey beverage containers around an at least partially circular, oval, ring, or custom route shaped processing station.

In an embodiment of the present invention, the beverage plant may further comprise a central computer, wherein the driving surface communicates bidirectionally with the central computer via a communication channel, and wherein on the central computer an application is installed that monitors, controls and optimizes the conveying system, including monitoring and controlling motions, and optimizing functions and/or tasks and/or travelling paths of the mover

In a preferred embodiment, said application performs constant path optimization of the mover as a function of process path optimization of said beverage container.

In another embodiment in accordance with the present invention, the mover may move through an incline, three dimensionally (3D) curved, spiral or otherwise shaped, vertically and/or upside down on respectively a 3D shaped driving, vertical driving surface or a ceiling driving surface, and is adapted for holding a beverage container or package.

In a further embodiment, the mover may have a shape of a square, a rectangle, or a cuboid, or a round shape, or an oval shape, or any other shape preferable to place the beverage container or the package over it.

In a particular embodiment, a beverage plant may be provided wherein the mover may be displaced, moved or rotated in 6 degrees of freedom. In this case the mover may be able to translate, lift, rotate, orientate, tilt, vibrate, or swirl beverage containers, or any combination thereof.

In addition to supporting beverage containers, one or more movers or a group of movers may be configured to support other beverage equipment and/or processing stations for being moved, displaced, tilted and/or rotated in at least two, preferably at least six degrees of freedom of movement.

In a general embodiment in accordance with the present invention, a conveying system for a beverage plant as described throughout this text may be used in general for conveying beverage containers for all types of beverages, and in particular carbonated beverage containers, and/or packaging.

In an embodiment of the present invention, the beverage plant may be a carbonated beverage plant, i.e. a plant for processing carbonated beverages and carbonated beverage containers.

In a further embodiment of the present invention, the beverage plant may be a brewery plant.

### BRIEF DESCRIPTION OF DRAWINGS

FIG. 1 illustrates an exemplary environment of a planar conveying system, for use in a beverage plant in accordance with an embodiment of the present invention;

FIG. 2 illustrates an exemplary environment showing multiple movers placed over the driving surface comprising multiple planar tiles, in a planar conveying system for use in a beverage plant in accordance with an embodiment of the present invention;

FIG. 3 illustrates an exemplary environment showing a vertical movement of the mover coupled with the planar tile, for use in a beverage plant in accordance with an embodiment of the present invention;

### DETAILED DESCRIPTION

The present invention provides a beverage plant comprising planar conveying system which is highly integrated, flexible, programmable, and dynamic with multi-dimensional freedom of movement. Such planar conveying system may be used for conveying beverage containers and/or packaging. It may be used in the wet part of the beverage plant, as well as in the dry part. The planar conveying system comprises of at least one driving surface and at least one planar moving part, also referred to as a planar mover, or mover. The at least one driving surface further comprises of plurality of planar tiles which include flat coils, and the at least one mover is equipped with a permanent magnet. The mover is levitated above planar tiles that generate a magnetic field. These planar tiles are adapted to detect the mover position. As a result, the mover moves freely, in a levitated motion over the driving surface under the effect of electromagnetic forces generated due to the electromagnetic coil in the driving surface and the permanent magnet in the mover.

A crucial advantage of the present invention is that planar movers accelerate, decelerate, rotate jerk-free and contactless over the planar tiles and enable avoiding shocks that could results in spoiling or even felling over of beverage containers. In addition, the planar tiles constituting the driving surface can be installed in any layout as is suitable in the beverage plant to form the driving surface. The movers are levitated and maintained at a certain distance (clearance) from the driving surface by means of electromagnetic forces. As such, very dynamic positioning of the movers is possible such that conventional conveying may be limited, resulting in a decrease in conveying foot print and size of the beverage plant. In addition, since each individual beverage container may be conveyed on an individual mover, contact pressure between containers in for example buffers may be avoided.

In an embodiment of a beverage plant in accordance with the present invention, the driving surface communicates with a central computer system via a communication interface. In an embodiment, the communication interface is a communication field bus. The central computer system is installed with application software which further controls and monitors the overall conveying system, including the movement and positioning of the movers over the driving surface, analyze best travelling path for the mover, analyze for avoiding collisions between the movers and provides real time path or task adaptation, among other relevant functions.

The mover or plurality of movers has multi-dimensional degrees of freedom of movement. In an embodiment, the movers have six degrees of freedom of movement, along the three axes, x-, y- and z-axes, and rotation along these axes, α, β, γ orientation. In addition, in a particular embodiments, the movers may be able to orientate, tilt, swirl, vibrate, or oscillate beverage containers, or any combination thereof. The mover may also be adapted to heat, or cool a beverage container.

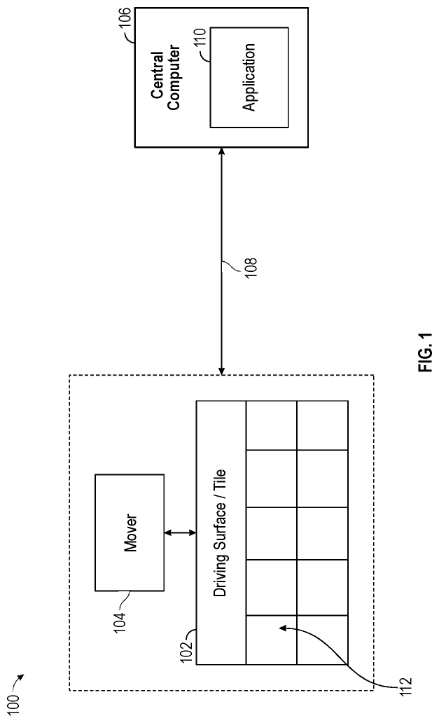

FIG. 1 illustrates an exemplary environment of a planar conveying system for use in a beverage plant in accordance with an embodiment of the present invention. The planar conveying system 100 comprises at least one driving surface 102, at least one mover 104 and at least one central computer 106. The driving surface 102 communicates bi-directionally with the central computer 106 via a communication channel 108. The central computer 106 is installed with an application 110 that monitors, controls and optimizes the overall planar conveying system 100, including the one driving surface 102 and the mover 104.

The application 110 ensures constant path optimization and collision avoidance. The application 110 runs on central computer 106.

The driving surface 102 further comprises a plurality of planar tiles 112, where each planar tile 112 is highly integrated, is flexible in use for layout configurations and performs all relevant functions. The tiles 112 can be arranged in configurations to suit any need. For performing different relevant functions, each tile 112 includes a sensor unit for detecting position of the mover over it; flat coils to generate travelling magnetic field for the movers to travel over it. The planar tiles 112 may also be able to communicate, collectively with the central computer 106, from the driving surface 102 via the communication channel 108.

In an embodiment of the present invention, when the tiles 112 are laid out in a surface arrangement, the tiles 112 keep distances between multiple processing stations short by flexible shortcutting and provide room to accommodate buffer zones. In another embodiment, the tiles 112 can be arranged in linear pathways. Further, in another embodiment, additional tiles can be laid along the pathways in order to create waiting zones, or to create short-cuts to avoid heavy mover traffic, avoid collisions etc.

The pathways in a beverage plant may also be built such that a circular, or oval, or swarm effect, planar movement of movers is achieved. This may be suitable for moving beverage bottles along processing stations or machines having circular, or oval, or mass migration configurations.

In further embodiment, a beverage plant may be provided where the conveying system comprises planar movers operating inclined, curved, three dimensionally (3D) shaped, vertically and even upside down moving over a respective inclined, curved, three dimensionally (3D) shaped, vertical, or upside down driving surface.

In an embodiment, planar movers may operate in group for carrying higher loads, for example heavy secondary packaging or tertiary packaging of beverage containers.

The central computer is installed with the application 110, which may analyze the positioning measurements of the movers 104 and can provide optimized paths, or positioning, or track management functions to the computer 106, to further monitor and control the position and movements of the movers 104 over the planar tiles 112. The application 110 can further provide real time path or task adaptation by constantly analyzing movers position feeds received from the sensor units of the planar tiles 112.

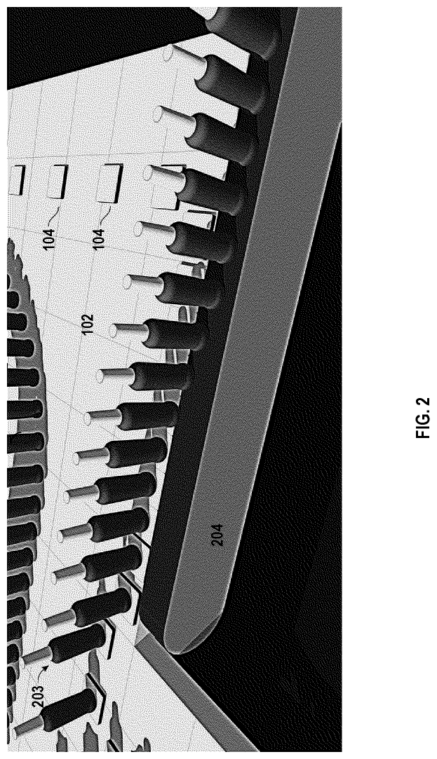

In FIG. 2 an exemplary beverage plant is illustrated comprising a conveying system wherein multiple planar movers 104 move over the driving surface 102 and receive beverage containers 203 from a beverage container processing station 204 for conveying to another processing station.

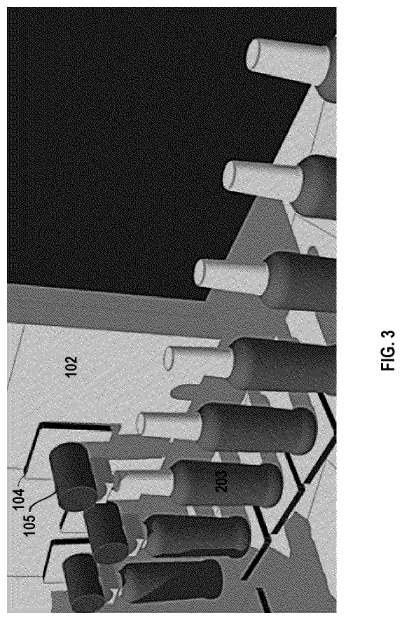

In FIG. 3 an exemplary beverage plant is illustrated comprising a conveying system wherein multiple planar movers 104 move over a vertical driving surface 102, wherein some of the movers have means 105 for holding a beverage container 203. As illustrated, the movers on the vertical driving surface may be enabled to pick the beverage containers from movers on the horizontal driving surface for further conveying.

The planar tiles of the driving surface may have any suitable size and shape enabling combination to any desired layout.

In a beverage plant in accordance with the present invention, planar movers may for example overtaking others, where the movers 104 can change lane and accelerate. Planar movers may for example park, where movers 104 can be extracted from the product flow, and parked for some time. Planar movers may for example divide or merge or sort, re-sequence or re-order product flows, eg. diversion of a product flow into several or single channels or lanes or to several parallel processing system, merge from several process system, sort like products or re-sequence or dynamically rearrange the order of different products for e.g. multi-packing. Movers may rotate beverage containers to orient and/or to form a defined pattern layer design with multiple movers and containers or group of containers on the movers.

Application 110 of a central computer 106, with the help of external devices, such as cameras, sensor units, and the like scans the system 100, may be adapted to configure the geometry of tiles 112 to identify the layout of the driving surface 102, identify the movers 104, and sense the position of the movers 104. In ongoing operation, the application 110 carries out the calculation of the mover position, precise position control, as well as monitoring and diagnostics. Each mover 104 is identified by the application 110 including XYZ coordinates as well as the angles of rotation α, β, or γ of these 3 axes. Helpful items of information such as current consumptions, lag errors, temperature and many others simplify diagnostics and enable integration of additional functions, such as weighing or heating of products.

In an additional embodiment in accordance with the present invention, in addition to supporting beverage containers, one or more movers or a group of movers are configured to support other beverage equipment and/or processing stations for being moved, displaced and/or rotated in at least six degrees of freedom of movement. The beverage equipment, in the planar conveying system 100, are transported between conventional processing tools and methods. The planar conveying system 100 can be used to transport primary packaging (such as bottles, cans, kegs, or secondary packaging (such as boxes, cartons, crates and the like), or tertiary packaging (such as cases or trays of packed product and the like). Further, the system 100 may be used in the dry and wet part of the beverage plant.

Further, in an embodiment, the system 100 may be combined with a linear motor driven conveying system, or any conventional conveying system for transporting the products. In an exemplary situation, a conventional (chain belt, or linear drive) grouper may pre-group the beverage containers before the movers pick them up and bring them to an beverage container picker (e.g. bottle picker).

Further, in an embodiment of the present invention, one or more movers have tooling and/or sensors mounted on it, said tooling and/or sensors being wireless powered and wireless automation controlled. The system 100 may be equipped with wireless power and wireless automation control on the planar movers for tooling and/or sensors mounted on the movers, enabling smart, programmable, energized actions on the movers in an untethered fashion.

Further, in an embodiment, the system 100 is able to operate between intermittent/continuous processing, because the system 100 can have layout configurations with parking zones, waiting zones, buffering zones, overtaking lanes and the like. Therefore, the products may be transported intermittently between different processing stations or continuously to every handling or processing station.

A conveying system as described throughout this text may result in a more hygienic beverage plant. Further, conveying may produce significantly less noise within the beverage plant. Also, conveying may occur with less mechanical abrasion and less release of particles.

The movers further offer excellent cleanability, chemically resistant surfaces and hygienic product handling. The contact free movement of the movers provides no friction and no wear, and even allows conveying beverage containers having other geometries than cylinder-based geometries.

While certain embodiments have been described, these embodiments have been presented by way of example only, and are not intended to limit the scope of the present disclosure. Indeed, the novel methods, devices, and systems described herein may be embodied in a variety of other forms. Furthermore, various omissions, substitutions, and changes in the form of the methods, devices, and systems described herein may be made without departing from the spirit of the present disclosure.

1. A beverage plant comprising a conveying system, said conveying system comprising:
at least one driving surface including at least one planar tile equipped with at least one coil;
at least one mover equipped with at least one permanent magnet for magnetically coupling the at least one mover to the at least one planar tile, the at least one mover being placed over the at least one tile of the at least one driving surface in a contactless manner and being configured to be moved, displaced and/or rotated in at least two degrees of freedom of movement;
wherein the at least one mover is configured to support at least one beverage container or at least one package containing at least one beverage container for being moved, displaced and/or rotated in at least two degrees of freedom of movement.

2. The beverage plant of claim 1, wherein the driving surface connects at least one beverage container processing station with another one.

3. The beverage plant of claim 1, wherein the driving surface is extended through one or more beverage container processing stations.

4. The beverage plant of claim 1, wherein the driving surface is at least partially in a circular or oval layout, or a ring shape layout around one or more beverage container processing stations.

5. The beverage plant of claim 1, further comprising central computer, wherein the driving surface communicates bidirectionally with the central computer via a communication channel, and wherein on the central computer an application is installed that monitors, controls and optimizes the conveying system, including monitoring and controlling motions, and optimizing functions and/or tasks and/or travelling paths of the mover.

6. The beverage plant of claim 3, wherein the application performs constant path optimization of the mover as a function of process path optimization of said beverage container.

7. The beverage plant of claim 1, wherein the mover is moving vertically and/or upside down on respectively a vertical driving surface or a ceiling driving surface, and wherein the mover has means for holding a beverage container.

8. The beverage plant of claim 1, wherein the mover is in a shape of a square or a rectangle, or a cuboid, or a round shape, or an oval shape, or any other shape preferable to place the beverage container or the package over it.

9. The beverage plant of claim 1, wherein the mover can be displaced, moved or rotated in 6 degrees of freedom.

10. The beverage plant of claim 1, wherein, in addition to supporting beverage containers, one or more movers or a group of movers are configured to support other beverage equipment and/or processing stations for being moved, displaced and/or rotated in at least two degrees of freedom of movement.

11. The beverage plant of claim 1, wherein one or more movers have tooling and/or sensors mounted on it, said tooling and/or sensors being wireless powered and wireless automation controlled.

12. The beverage plant according to any of foregoing claims of claim 1, wherein the beverage plant is a carbonated beverage plant.

13. The beverage plant according to any of foregoing claims of claim 1, wherein the beverage plant is a brewery plant.
